(19) United States
(12) Patent Application Publication
(10) Pub. No.: US 2013/0241917 A1
(43) Pub. Date: Sep. 19, 2013

(54) DISPLAY DEVICE, AND DISPLAY METHOD THEREFOR

(71) Applicant: Yoshinori Shibata, Osaka (JP)

(72) Inventor: Yoshinori Shibata, Osaka (JP)

(73) Assignee: SHARP KABUSHIKI KAISHA, Osaka (JP)

(21) Appl. No.: 13/988,704

(22) PCT Filed: Nov. 18, 2011
(86) PCT No.: PCT/JP2011/076702

§ 371 Date: May 21, 2013

(30) Foreign Application Priority Data
Nov. 25, 2010 (JP) 2010-262844

(51) Int. Cl. G09G 3/36

(52) U.S. Cl. CPC G09G 3/3696
USPC 345/212

(57) ABSTRACT

When driving an eight-color display region, a source amplification circuit (15) supplies a voltage without using a source amplifier (7) by switching a switch (SW0) to a contact point (A), and by turning off switches (SW1 to SWn). On the other hand, when driving the full-color display region, by switching the switch SW(0) to a contact point B, and by turning on one of the switches (SW1 to SWn) (“n” is an integer), a voltage for displaying a desired gradation is supplied through the source amplifier 7.

### TECHNICAL FIELD

The present invention relates to a display device driven by switching a mode using a source amplifier and a mode not using a source amplifier between each other, and a display method therefor.

### BACKGROUND ART

In recent years, display devices with thin-profile, light-weight, and low power consumption such as liquid crystal display devices are widely used. Such display devices are mainly used for mobile phones, smartphones, lap-top personal computers, and the like, for example. Also, an electronic paper, which is an even thinner display device, is expected to be developed and put in practical use at a fast pace in the coming years. Against such a background, reducing power consumption is a common challenge that various display devices face currently.

In order to reduce power consumption, in display devices such as liquid crystal display devices, a technique for actively changing power consumption of a backlight for different display regions is proposed. By using such a technique, the power consumption of the backlight can be reduced, but in other parts than the backlight (such as a panel part including a timing controller, a driver, and the like), a certain amount of power is constantly consumed regardless of the display regions. As a result, when contents that require less power were displayed, more power than necessary was consumed.

To address this issue, Patent Document 1 discloses a technique for reducing power consumption in other parts than the backlight. Specifically, the device is configured to detect whether or not a higher-order L bit of image data coincides with a higher-order L bit of the previous data, and when they coincide with each other, the device is driven with a lower driving power. More specifically, when the device detects that only the respective higher-order L bits coincide with each other, it is determined that a difference in image data, which corresponds to a source output voltage, is small, and data signal lines are driven by a second driving power, instead of a first driving power that has a higher consumption current. On the other hand, when the device detects that the respective high-order L bits do not coincide with each other, it is determined that a difference in image data, which corresponds to a source output voltage, is large, and data signal lines are driven by the first driving power that has a higher consumption current first, and then driven by the second driving power. As described above, by changing a current driving power based on a comparison result between gradation data during the driving period and the previous data corresponding to the driving level of the preceding period, it is possible to reduce the consumption current.

### RELATED ART DOCUMENT

### Patent Document

Patent Document 1 Japanese Patent Application Laid-Open Publication, “Japanese Patent Application Laid-Open Publication No. 2009-9018 (Published on Jan. 15, 2009)”

### SUMMARY OF THE INVENTION

### Problems to be Solved by the Invention

However, with the above-mentioned technique disclosed in Patent Document 1, it is not possible to reduce the power consumption to a sufficient level. This is because, with the technique disclosed in Patent Document 1, it is not possible to intentionally reduce the driving power of source amplifiers for a specified region. Also, between a white image and a black image, values in all bits differ from each other, and therefore, even in eight-color display, it is not necessarily true that the driving power for the source amplifiers is always made lower. Thus, even when there is a region that constantly displays in eight colors, it is not possible to ensure that data signal lines are driven with less power.

The present invention was made in view of the above-mentioned problems, and an object thereof is to provide a display device that can more effectively reduce the power consumed to drive data signal lines, and a display method therefor.

### Means for Solving the Problems

In order to solve the above-mentioned problems, a display device according to one embodiment of the present invention includes: a display screen having a plurality of scan signal lines, a plurality of data signal lines intersecting with the plurality of scan signal lines, and a plurality of pixels provided for respective intersections of the plurality of scan signal lines and the plurality of data signal lines, the display screen being divided into an eight-color display region that performs eight-color display and a full-color display region that performs full-color display; a power source that supplies a voltage; a source amplifier circuit provided for each of the data signal lines, the source amplifier circuit including a supply wiring line that supplies the voltage from the power source to each of the data signal lines and a source amplifier that supplies the voltage from the power source to each of the data signal lines; a calculation part that calculates a gradation voltage for each of the pixels in accordance with a display region in which the pixel is present, based on an image signal inputted from an exterior, the gradation voltage corresponding to a gradation to be displayed in the pixel; and a control part that causes the gradation voltage calculated by the calculation part to be supplied to each of the data signal line corresponding to the pixels included in the eight-color display region through the supply wiring line from the power source, the control part also causing the gradation voltage calculated by the calculation part to be supplied to each of the data signal lines corresponding to the pixels included in the full-color display region through the source amplifier from the power source.

With this configuration, the display device of an embodiment of the present invention performs full-color display in a region of the display region, and performs eight-color display in other regions. The control part supplies voltages corresponding to the eight-color display to the display region that performs the eight-color display, and supplies voltages corresponding to the full-color display to the display region that performs the full-color display. More specifically, when the eight-color display is performed, voltages corresponding to the eight-color display are supplied without using source amplifiers, and when the full-color display is performed, voltages corresponding to the full-color display are supplied through the source amplifiers.

As described above, in the display device of an embodiment of the present invention, a mode in which display is performed by using source amplifiers and a mode in which display is performed without using source amplifiers are switched between each other depending on the display region. This makes it possible to more effectively reduce the power consumed to drive the data signal lines. As a result, the power consumption in the display device can be reduced.

In order to solve the above-mentioned problems, a display method for a display device according to an embodiment of the present invention is a display method for a display device that includes: a display screen including a plurality of scan signal lines, a plurality of data signal lines intersecting with the plurality of scan signal lines, and a plurality of pixels provided for respective intersections of the plurality of scan signal lines and the plurality of data signal lines; and a power source that supplies a voltage, the display screen being divided into an eight-color display region that performs eight-color display and a full-color display region that performs full-color display, the display method including: a calculation step of calculating a gradation voltage for each of the pixels in accordance with a display region in which the pixel is present, based on an image signal inputted from an exterior, the gradation voltage corresponding to a gradation to be displayed in the pixel; and a control step of causing the gradation voltage calculated in the calculation step to be supplied to each of the data signal lines corresponding to the pixels included in the eight-color display region through the supply wiring line from the power source, and causing the gradation voltage calculated in the calculation step to be supplied to each of the data signal lines corresponding to the pixels included in the full-color display region through the source amplifier from the power source.

According to the above-mentioned method, it is possible to provide a display method that can more effectively reduce the power consumed to drive the data signal lines.

Additional objects, features, and effects of the present invention shall be readily understood from the descriptions that follow. Advantages of the present invention shall become apparent by the following descriptions with reference to the appended drawings.

### Effects of the Invention

According to the display device of an embodiment of the present invention, a mode in which display is performed by using source amplifiers and a mode in which display is performed without using source amplifiers are switched with each other depending on the display region. This makes it possible to more effectively reduce the power consumed to drive the data signal lines. As a result, the power consumption in the display device can be reduced.

### BRIEF DESCRIPTION OF THE DRAWINGS

FIG. 1 is a circuit diagram showing a source amplifier circuit provided for each data signal line according to an embodiment of the present invention.

FIG. 2 is a diagram showing an overall configuration of a display device of one embodiment of the present invention.

FIG. 3 is a block diagram showing a main part configuration of a source voltage output part of an embodiment of the present invention.

FIG. 4 is a flowchart showing a flow of the voltage output conducted by the source output voltage generating part of an embodiment of the present invention.

FIG. 5 is a schematic view that shows a display device of an embodiment of the present invention.

FIG. 6 is a schematic view that shows a display screen of an embodiment of the present invention.

FIG. 7 is a diagram showing an example of a display screen when the display device of an embodiment of the present invention is used for an electronic reader.

FIG. 8 is a diagram showing an example of a display screen when the display device of an embodiment of the present invention is used for a digital television receiver.

FIG. 9 is a diagram showing an example of a display screen when the display device of an embodiment of the present invention is used for a mobile phone.

FIG. 10 is a circuit diagram showing a source amplifier circuit provided for each data signal line of another embodiment of the present invention.

FIG. 11 is a schematic view that shows a display screen of an embodiment of the present invention.

### DETAILED DESCRIPTION OF EMBODIMENTS

Below, embodiments of a display device of the present invention will be explained in detail with reference to figures.

(Configuration of Display Device 1)

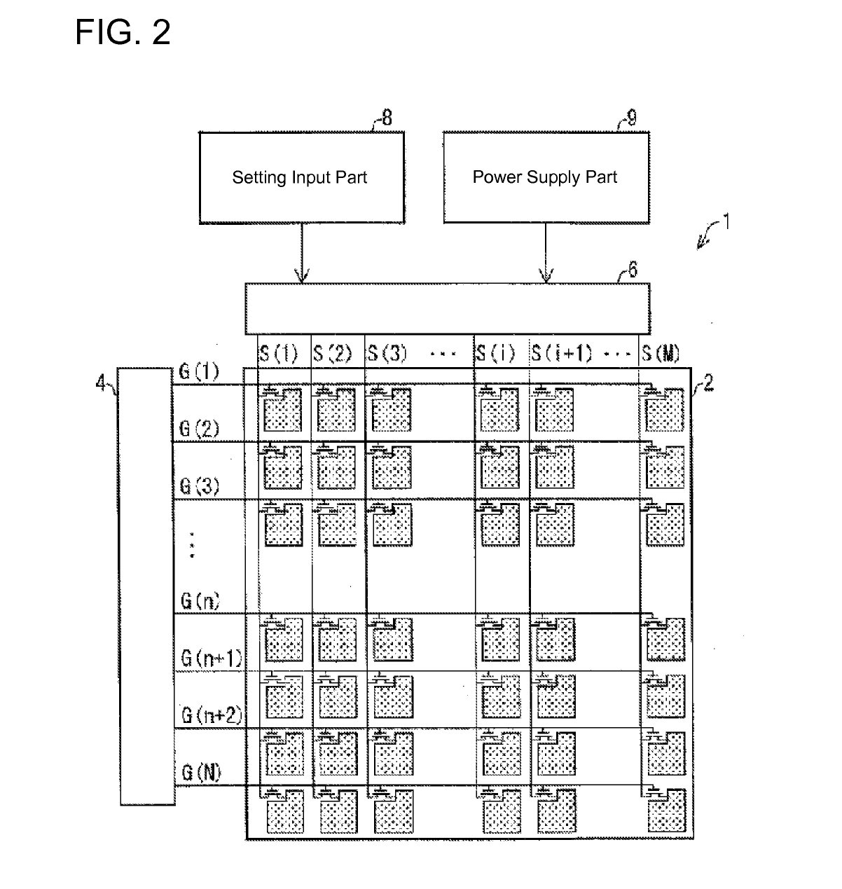

First, a configuration of a display device of the present embodiment will be explained with reference to FIG. 2. FIG. 2 is a diagram showing an overall configuration of the display device 1.

As shown in FIG. 2, the display device 1 includes a display section 2, a gate voltage output part (gate driver) 4, a source voltage output part (source driver) 6, a setting input part 8 (user input part), and a power supply part 9. The display section 2 includes: a screen constituted of a plurality of pixels arranged in a matrix, N number (N is an integer) of scan signal lines G (gate lines) to select and scan the screen in a line-sequential manner, and M number (M is an integer) of data signal lines S (source lines) for supplying data signals to pixels for one row of the selected line. The scan signal lines G and the data signal lines S are arranged so as to intersect with each other, and pixels are provided for the respective intersections. That is, a region enclosed by two adjacent scan signal lines G and two adjacent data signal lines S is one pixel.

G(n) in FIG. 2 represents the n-th (“n” is an integer) scan signal line G. For example, G(1), G(2), and G(3) respectively represent the first, second, and third scan signal lines G. On the other hand, S(i) represents the i-th (“i” is an integer) data signal line S. For example, S(1), S(2), and S(3) respectively represent the first, second, and third data signal lines S.

The gate voltage output part 4 scans the respective scan signal lines G from top to bottom of the screen in a line-sequential manner. While scanning, the gate voltage output part 4 outputs to each of the scan signal lines G a square wave to turn on a switching element (TFT) that is provided for each pixel and that is connected to each pixel electrode. This way, pixels for one row in the screen are selected.

The source voltage output part 6 calculates, based on the received image signal, values of voltages to be outputted to the respective pixels for the selected one row, and outputs the voltages of the calculated values to the respective data signal lines S. As a result, image data is supplied to the respective pixels on the selected scan signal line G. At this time, the display device 1 performs full-color display in one region of the display region and performs eight-color display in other regions. The source voltage output part 6 supplies voltages (gradation voltage) corresponding to full-color display to the display region where the full-color display is performed, and supplies voltages (gradation voltage) corresponding to eight-color display to the display region where the eight-color display is performed, based on information inputted from the setting input part 8. The detailed configuration of the source voltage output part 6 will be later described, but as described above, power consumed in the source voltage output part 6 is reduced by performing full-color display in a part of the display region.

The power supply part 9 supplies voltages necessary for the display device 1 to operate. Specifically, the power supply part 9 outputs voltages for driving the gate voltage output part 4 and the source voltage output part 6 to the gate voltage output part 4 and the source voltage output part 6, respectively.

(Configuration of Source Voltage Output Part 6)

As described above, the display device 1 performs full-color display in one region of the display region, and performs eight-color display in other regions. More specifically, the display device 1 performs full-color display in a region specified by a user, and performs eight-color display in other regions. For example, the display device 1 performs full-color display in a region on the display screen where full-color display is desired (more precisely, in a region where the user decided the full-color display should be performed).

A user specifies a region to perform the full-color display on the display screen through the setting input part 8. Examples of the specifying method include, when the display device 1 is a liquid crystal display device, for example, a method of using register setting with serial interface and transmitting information to the display device 1. The source voltage output part 6 outputs voltages corresponding to full-color display to the full-color display region specified by the user, and outputs voltages corresponding to eight-color display to the other region, which is an eight-color display region.

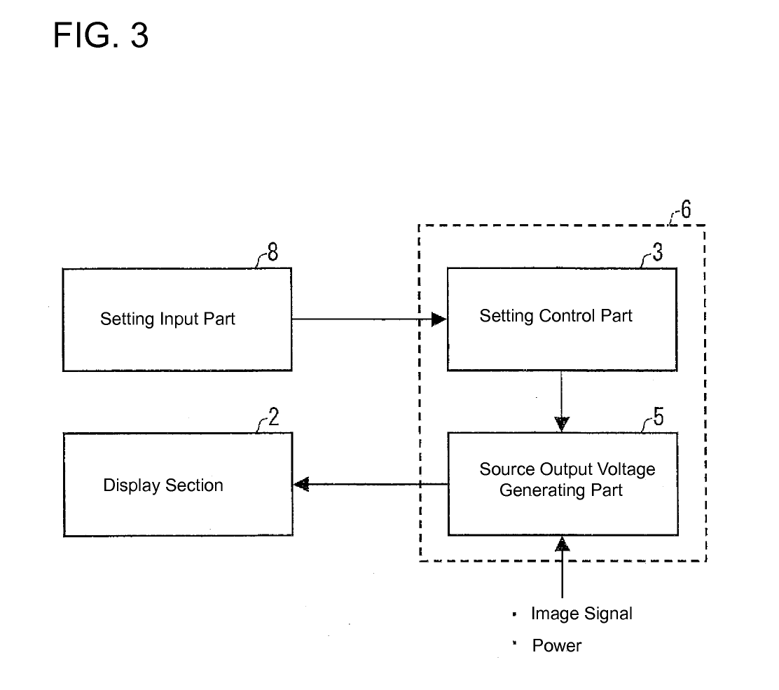

Below, the configuration of the source voltage output part 6 will be explained in further detail with reference to FIG. 3. FIG. 3 is a block diagram showing a main part configuration of the source voltage output part 6.

As shown in FIG. 3, the source voltage output part 6 includes a setting control part 3 (control part) and a source output voltage generating part 5 (calculation part). The information regarding the full-color display region specified by the user is inputted to the setting control part 3 from the setting input part 8. Based on the information from the setting input part 8, the setting control part 3 controls the source output voltage generating part 5 such that prescribed voltages are outputted to the full-color display region through the source amplifiers, and such that prescribed voltages are outputted to the eight-color display region without using the source amplifiers. More specifically, for each scan signal line G, the source output voltage generating part 5 is controlled by the setting control part 3 such that, to the data signal lines S corresponding to the full-color display region, prescribed voltages are outputted through source amplifiers, and such that, to the data signal lines S corresponding to the eight-color display region, prescribed voltages are outputted without using source amplifiers.

When the source output voltage generating part 5 calculates values of voltages to be outputted, based on image signals provided from the outside, the source output voltage generating part 5 calculates voltage values corresponding to the full-color display for the data signal lines S that are controlled by the setting control unit 3 so as to perform the full-color display (so as to use the source amplifiers). On the other hand, the source output voltage generating part 5 calculates voltage values corresponding to the eight-color display for the data signal lines S that are controlled by the setting control unit 3 so as to perform the eight-color display (so as not to use the source amplifiers). The source output voltage generating part 5 outputs voltages of the calculated values to the respective data signal lines S in the display section 2.

(Configuration of Source Output Voltage Generating Part 5)

The source output voltage generating part 5 includes a plurality of source amplifier circuits. The respective source amplifier circuits are provided for respective data signal lines S. Therefore, the source output voltage generating part 5 of the present embodiment includes M number of source amplifier circuits. That is, the number of the source amplifier circuits and the number of the data signal lines S are equal to each other.

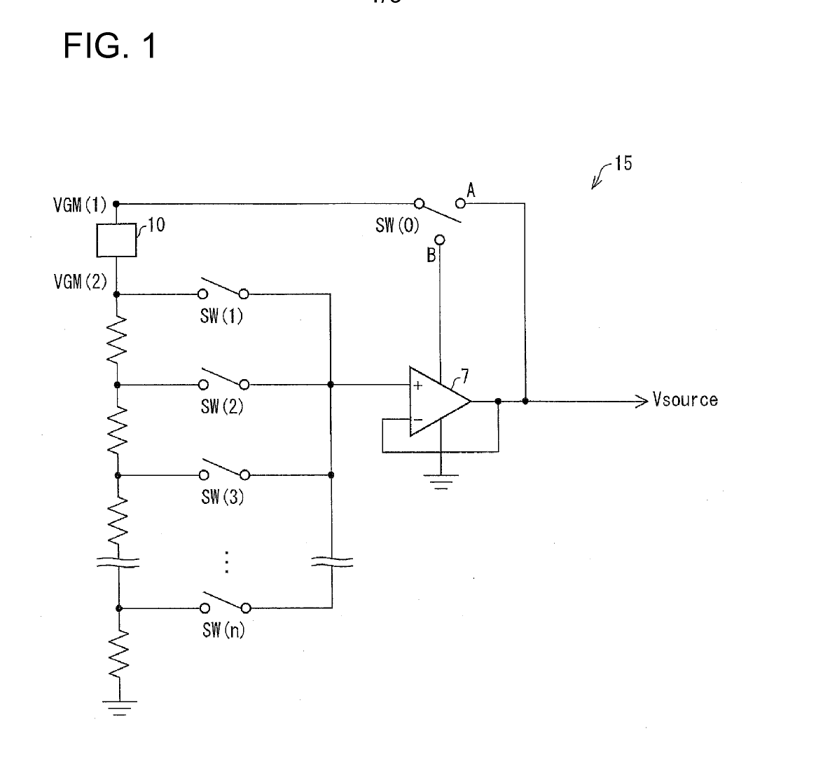

In each source amplifier circuit of the source output voltage generating part 5, a mode in which a prescribed voltage is outputted to each data signal line S without using a source amplifier and a mode in which a prescribed voltage is outputted by using a source amplifier can be switched between each other as needed. The source amplifier circuit provided for each data signal line S is shown in FIG. 1.

As shown in FIG. 1, the source amplifier circuit 15 includes two types of power sources (VGM(1) (first power source) and VGM(2) (second power source); power source). These power sources may supply voltages generated by a not-shown power source circuit, based on a voltage from the power supply part 9, or the power supply part 9 itself may be used as the power source VGM(1). In this case, as shown in FIG. 1, it is preferable to convert the voltage from the power source VGM(1) to a voltage to be supplied from the power source VGM(2) by conducting voltage conversion through a regulator 10.

The power source VGM(1) is a power source that has a high current supply capacity, while having a low supply voltage accuracy. On the other hand, the power source VGM(2) is a power source that has a low current supply capacity, while having a high supply voltage accuracy. When driving the eight-color display region, because there are only two gradation levels (high level and low level), an effect of slight variation in voltage on the display quality of the display device 1 is smaller than that in the full-color display. Thus, when driving the eight-color display region, by switching a switch SW (0) to a contact point A, and by turning off switches SW (1) to SW(n), a voltage (high gradation voltage or low gradation voltage) is directly supplied to each data signal line S through a wiring line (supply wiring line) that connects the power source VGM(1) to each data signal line S. That is, a voltage is supplied without using a source amplifier 7.

On the other hand, when driving the full-color display region, by switching the switch SW(0) to a contact point B, and by turning on one of the switches SW(1) to SW(n) (n is an integer), a voltage for displaying a desired gradation is supplied through the source amplifier 7. The voltage supplied from the power source VGM(2) is divided into voltages for displaying respective gradations (gradation voltages) by a resistor ladder. Therefore, by selecting a switch corresponding to a gradation level to be displayed, out of the switches SW(1) to SW(n), a voltage for displaying the specific gradation level can be outputted.

The switch SW(0) is controlled by the setting control part 3 so as to be switched to the contact point A when performing the eight-color display, and so as to be switched to the contact point B when performing the full-color display. That is, for each scan signal line G, the setting control part 3 switches the switch SW(0) to the contact point A when outputting a prescribed voltage to each data signal line S corresponding to the eight-color display region, and switches the switch SW(0) to the contact point B when outputting a prescribed voltage to each data signal line S corresponding to the full-color display region.

The power source that has a high current supply capacity and a low supply voltage accuracy means a power source that has a higher current supply capacity and a lower supply voltage accuracy as compared with a power source that has a low current supply capacity and a high supply voltage accuracy. In other words, if the power source VGM(1), which is used when driving the eight-color display region, has a lower supply voltage accuracy and a higher current supply capacity than those of the power source VGM(2), which is used when driving the full-color display region, they can be used for the source voltage output part 6 of the display device 1 of the present embodiment.

(Voltage Output by Source Output Voltage Generating Part 5)

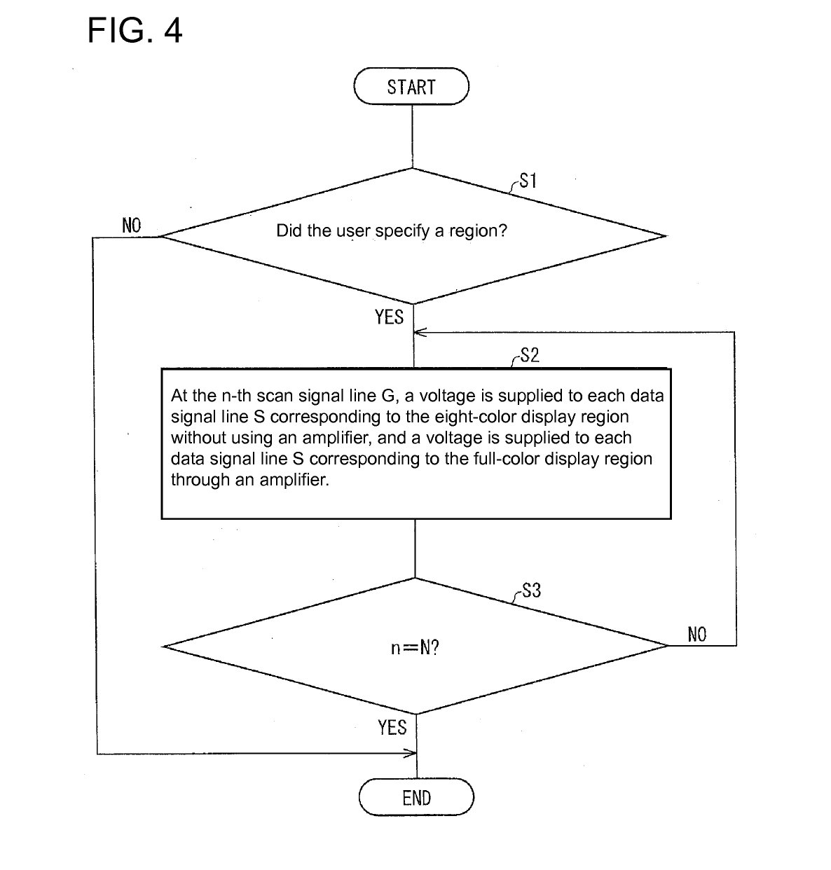

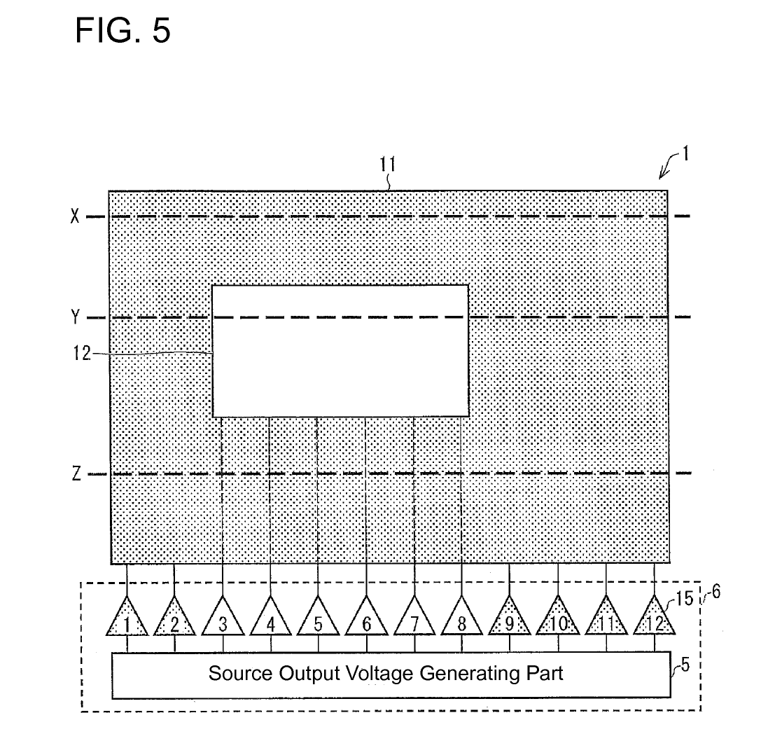

Below, specific procedures of voltage output by the source output voltage generating part 5 will be explained according to FIG. 4 with reference to FIG. 5. FIG. 4 is a flowchart showing a flow of the voltage output by the source output voltage generating part 5. FIG. 5 is a schematic view of the display device 1.

To make it easier to explain the voltage output by the source output voltage generating part 5, FIG. 5 shows the display device 1 having twelve data signal lines S as an example. The display screen of the display device 1 has an eight-color display region 11 and a full-color display region 12.

First, information regarding the full-color display region 12 specified by the user is inputted to the setting control part 3 from the setting input part 8. If the user did not specify the full-color display region 12 (NO in a step S1 (will be abbreviated as S1 below) in FIG. 4), a normal image display is performed. In other words, full-color display using the source amplifiers 7 is conducted.

On the other hand, when the user specified the full-color display region 12, (YES in S1), the setting control part 3 controls the source output voltage generating part 5 such that eight-color display is performed in the eight-color display region 11 and full-color display is performed in the full-color display region. At this time, as described above, the gate voltage output part 4 scans N number of (N is an integer) scan signal lines G from top to bottom of the screen in a line-sequential manner, and selects pixels for one row in the screen. The source output voltage generating part 5 of the source voltage output part 6 calculates values of voltages to be outputted to respective pixels in the selected one row, based on provided image signals, and outputs voltages of the calculated values to the respective data signal lines S from the source amplifier circuits 15.

Table 1 shows voltages outputted to the respective pixels (data signal lines S) of respective lines when pixels on a line X, a line Y, and a line Z out of the scan signal lines G are respectively selected, for example. The numbers 1 to 12 in Table 1 correspond to the numbers given to the respective source amplifier circuits 15 shown in FIG. 5.

TABLE 1

| | 1 | 2 | 3 | 4 | 5 | 6 | 7 | 8 | 9 | 10 | 11 | 12 |
|---|---|---|---|---|---|---|---|---|---|---|---|---|
| Line X | x | x | x | x | x | x | x | x | x | x | x | x |
| Line Y | x | x | ∘ | ∘ | ∘ | ∘ | ∘ | ∘ | x | x | x | x |
| Line Z | x | x | x | x | x | x | x | x | x | x | x | x |

∘: Source amplifier used
x: Source amplifier not used

The pixels on the line X are all included in the eight-color display region 11. Therefore, as shown in Table 1, in the source amplifier circuits 15 of No. 1 to No. 12, prescribed voltages are outputted to the corresponding data signal lines S, respectively, without using the source amplifiers 7. Next, when the pixels on the line Y of the scan signal lines G are selected, some of the pixels on the line Y are included in the full-color display region 12. In this case, prescribed voltages are outputted to the data signal lines S for the pixels included in the eight-color display region 11 without using the source amplifiers 7. That is, as shown in Table 1, in the source amplifier circuits 15 of No. 1, No. 2, and No. 9 to No. 12, prescribed voltages are outputted to the corresponding data signal lines S, respectively, without using the source amplifiers 7. On the other hand, to the data signal lines S for the pixels included in the full-color display region 12, prescribed voltages are outputted through the source amplifiers 7. That is, as shown in Table 1, in the source amplifier circuits 15 of No. 3 to No. 8, prescribed voltages are outputted to the corresponding data signal lines S, respectively, through the source amplifiers 7.

As described above, in the n-th scan signal line G (“n” is an integer equal to or smaller than N), prescribed voltages are outputted to the data signal lines S for pixels that correspond to the eight-color display region 11 without using the source amplifiers 7, and prescribed voltages are outputted to the data signal lines S for pixels that correspond to the full-color display region 12 through the source amplifiers 7 (S2). The process is repeated from the first scan signal line G to the N-th scan signal line G (NO in S3), and when the N-th scan signal line G is scanned, the process is completed (YES in S3).

(Setting of Eight-Color Display Region)

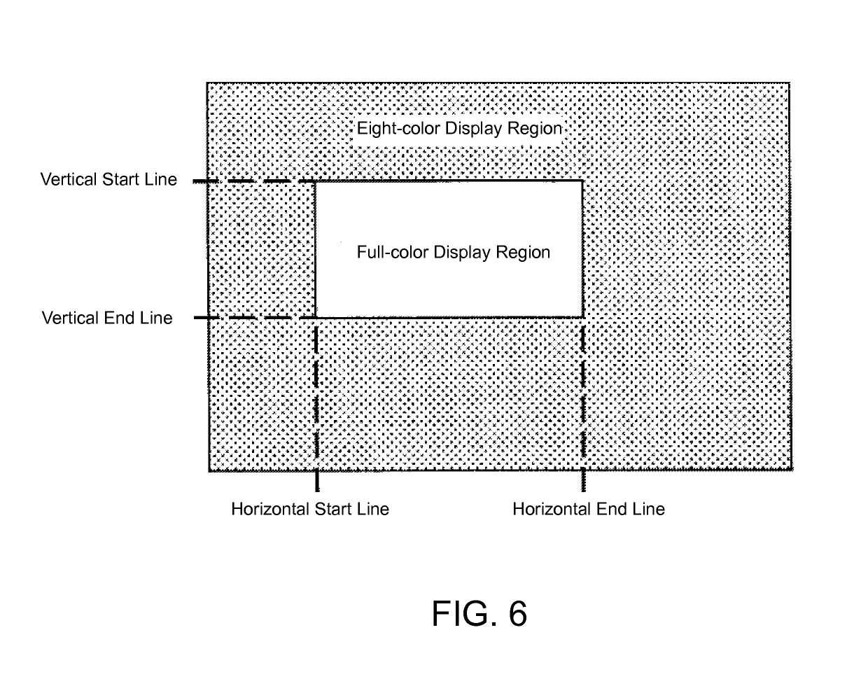

When a user specifies a region on the display screen where full-color display is to be performed through the setting input part 8, the user can specify any region on the display screen. Specific settings will be explained by using specific examples with reference to FIG. 6. FIG. 6 is a schematic view of the display screen.

As shown in FIG. 6, when the eight-color display region and the full-color display region are provided in the display screen, the user can specify the full-color display region based on the resolution (VGA) of the display screen, for example. Table 2 shows examples of setting ranges and setting values in such a case.

TABLE 2

| | Setting Range Example | Setting Value Example |
|---|---|---|
| Horizontal Start Line | 1-640 | 100 |
| Horizontal End line | 1-640 | 200 |
| Vertical Start Line | 1-480 | 150 |
| Vertical End Line | 1-480 | 350 |

When the full-color display region is specified based on the resolution of the display screen, as shown in FIG. 6, a data signal line S at a position where the full-color display region starts (horizontal start line) and a data signal line S at a position where the full-color display region ends (horizontal end line) in the horizontal direction (in which the data signal lines S are arranged) are selected. Similarly, a scan signal line G at a position where the full-color display region starts (vertical start line) and a scan signal line G at a position where the full-color display region ends (vertical end line) in the vertical direction (in which the scan signal lines G are arranged) are selected. For example, as shown in FIG. 2, when the resolution of the display screen is 640×480, the horizontal start line and the horizontal end line can be set within a range of 1 to 640. The vertical start line and the vertical end line can be set within a range of 1 to 480. By setting the horizontal start line to 100, the horizontal end line to 200, the vertical start line to 150, and the vertical end line to 350, the full-color display region shown in FIG. 6 can be specified.

As described above, by selecting scan signal lines G and data signal lines S that enclose a region where the full-color display is to be performed, the full-color display region can be specified. Also, by selecting desired scan signal lines G and data signal lines S, it is possible to specify a full-color display region of a desired size in a desired region.

An example in which the full-color display region is specified based on the resolution (VGA) was described above, but the present invention is not limited to such. Any method may be employed as long as it allows the user to specify the full-color display region. Also, an example in which the full-color display region is rectangular was described above, but the shape of the full-color display region is not limited to a rectangular shape. The user can specify a full-color display region in a desired shape.

(Effects)

As described above, in the display device 1 of the present embodiment, a mode in which display is performed by using the source amplifiers 7 and a mode in which display is performed without using the source amplifiers 7 can be switched between each other depending on the display region. This makes it possible to more effectively reduce the power consumed in the source voltage output part 6 to drive the data signal lines. As a result, the power consumption in the display device 1 can be reduced. When the full-color display is performed, in particular, voltages for displaying desired gradations can be supplied under the driving conditions with a sufficient current supply capacity.

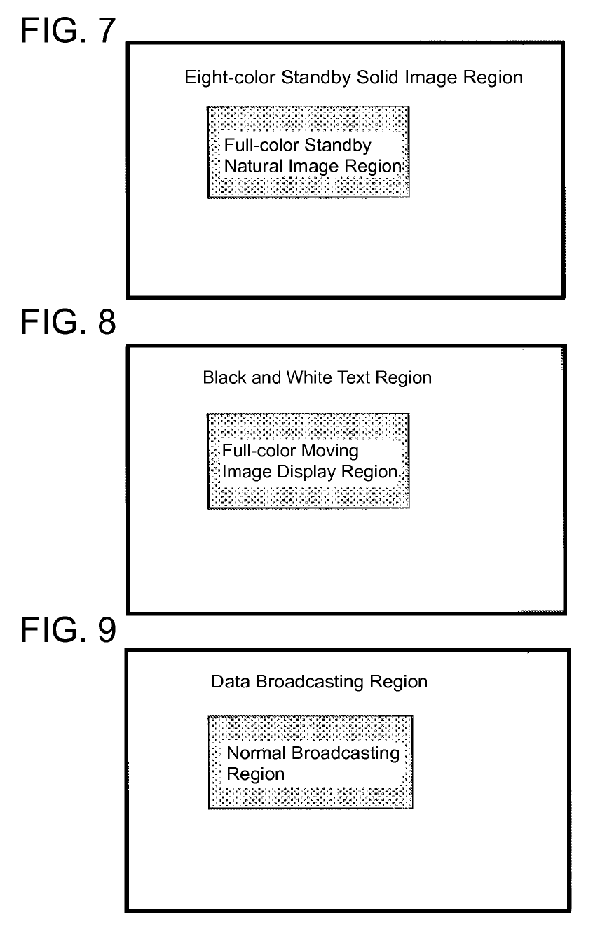

Below, examples of using the display device 1 of the present embodiment for various electronic devices will be explained briefly with reference to FIGS. 7 to 9. FIG. 7 is a diagram showing an example of a display screen when the display device 1 of the present embodiment is used for an electronic reader. FIG. 8 is a diagram showing an example of a display screen when the display device 1 of the present embodiment is used for a digital television receiver. FIG. 9 is a diagram showing an example of a display screen when the display device 1 of the present embodiment is used for a mobile phone.

For example, in some electronic readers, depending on an application, a region where only black and white texts are displayed and a region where a full-color moving image and the like are displayed are designated in advance. In this case, as shown in FIG. 7, by using the display device 1 of the present embodiment, and by setting the region where black and white texts are displayed to the eight-color display region, and setting the region where moving images and the like are displayed to the full-color display region, the power consumption can be reduced.

In some digital television receivers, depending on display contents, a region where data broadcasting is performed in eight-color display and a region where a normal broadcasting is performed are designated in advance. In this case, as shown in FIG. 8, by using the display device 1 of the present embodiment, and by setting the region where data broadcasting is performed to the eight-color display region, and setting the region where normal broadcasting is performed to the full-color display region, the power consumption can be reduced.

In some mobile phones, a region where only a solid image is displayed and a region where a full-color natural image is displayed during a standby mode are designated in advance. In this case, as shown in FIG. 9, by using the display device 1 of the present embodiment, and by setting the region where a solid image is displayed to the eight-color display region, and setting the region where a natural image is displayed to the full-color display region, the power consumption can be reduced.

### MODIFICATION EXAMPLE 1

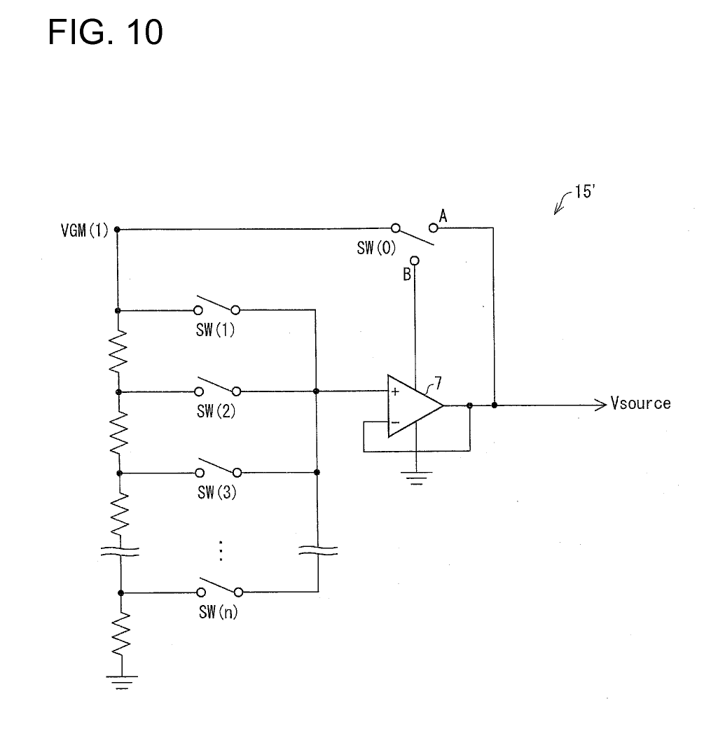

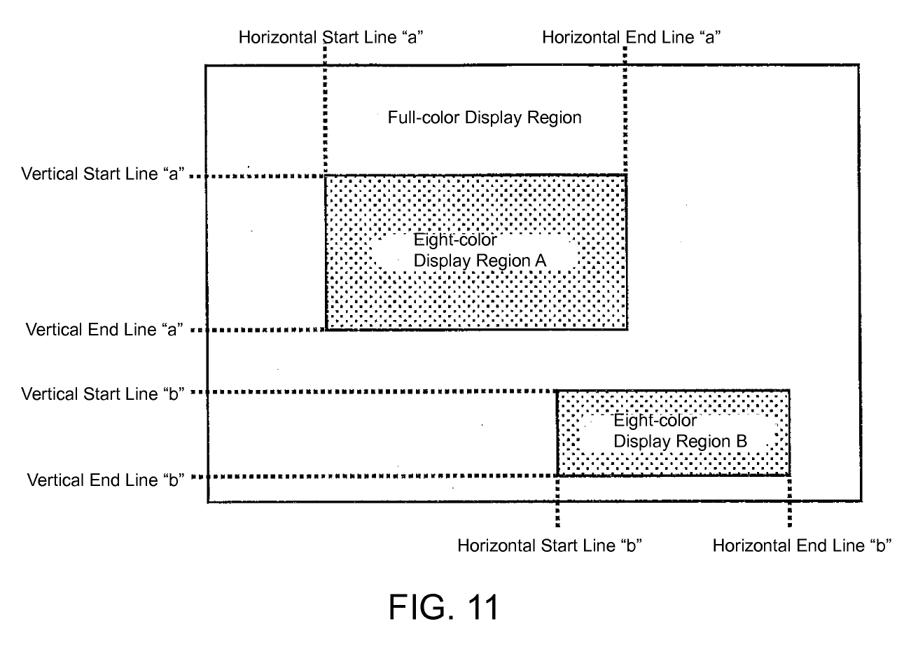

The configuration in which the source amplifier circuit 15 has two types of power sources (power source VGM(1) and power source VGM(2)) was described above, but the present invention is not limited to such. For example, voltages may be supplied only from the power source VGM(1). This configuration will be explained with reference to FIG. 10. FIG. 10 is a circuit diagram showing a source amplifier circuit provided for each data signal line S of another embodiment of the present invention.

As shown in FIG. 10, a source amplifier circuit 15′ has one power source (power source VGM(1)). When driving the eight-color display region, a high gradation voltage or a low gradation voltage is directly supplied to each data signal line S from the power source VGM(1) through a wiring line that connects the power source VGM(1) to each data signal line S. On the other hand, when driving the full-color display region, a desired gradation voltage is supplied to each signal line S through a resistor ladder and a source amplifier 7. The power source VGM(1) directly supplies a voltage (high gradation voltage and low gradation voltage) to each data signal line S through a wiring line (supply wiring line) that connects the power source VGM(1) to each data signal line S by switching the switch SW(0) to the contact point A, and by turning off the switches SW(1) to SW(n).

On the other hand, when driving the full-color display region, the switch SW(0) is switched to the contact point B, and by turning on one of the switches SW(1) to SW(n) (“n” is an integer), a voltage for displaying a desired gradation is supplied through the source amplifier 7. The power source VGM(1) may supply a voltage generated by a not-shown power source circuit, based on a voltage from the power supply part 9, or the power supply part 9 itself may be used as the power source VGM(1).

Although the above-mentioned source amplifier circuit 15 uses the power source VGM(1) and the power source VGM(2), it is possible to drive the display section 2 sufficiently only with one power source VGM(1) as in the source amplifier circuit 15′. Therefore, by switching a mode in which display is performed by using the source amplifiers 7 and a mode in which display is performed without using the source amplifiers 7 between with each other depending on the display region, it is possible to more effectively reduce the power consumed in the source voltage output part 6 to drive the data signal lines. As a result, the power consumption in the display device 1 can be reduced.

### MODIFICATION EXAMPLE 2

The configuration of specifying a region to perform full-color display on the display screen was described above, but the present invention is not limited to such. For example, the user may specify a region where eight-color display is to be performed on the display screen through the setting input part 8. That is, the display device may be configured such that the eight-color display is performed in the region specified by the user, and the full-color display is performed in other regions. For example, eight-color display is performed in a region where eight-color display does not cause a problem (more precisely, a region where the user decided the eight-color display can be performed).

Also, the display device may be configured such that a plurality of eight-color display regions (or full-color display regions) are specified. Specific settings in this case will be explained by using specific examples with reference to FIG. 10. FIG. 10 is a schematic view of the display screen.

As shown in FIG. 10, two eight-color display regions and a full-color display region are to be provided on the display screen. For example, when two eight-color display regions are specified based on the resolution of the display screen, a data signal line S at a position where an eight-color display region A starts (horizontal start line “a”) and a data signal line S at the end position (horizontal end line “a”) in the horizontal direction (in which the data signal lines S are arranged) are selected. Similarly, a scan signal line G at a position where the full-color display region starts (vertical start line “a”) and a scan signal line G at the end position (vertical end line “a”) in the vertical direction (in which the scan signal lines G are arranged) are selected. Furthermore, a data signal line S at a position where an eight-color display region B starts (horizontal start line “b”) and a data signal line S at the end position (horizontal end line “b”) in the horizontal direction are selected. Similarly, a scan signal line G at a position where the full-color display region starts (vertical start line “b”) and a scan signal line G at the end position (vertical end line “b”) in the vertical direction are selected.

As described above, when a plurality of eight-color display regions are provided, the respective regions are specified. When there are a plurality of eight-color display regions, it is possible to reduce the power consumption more than when only one eight-color display region can be specified. It is also possible to provide a plurality of full-color display regions. In this case, it is possible to address the need of the user when the user thinks the full-color display needs to be performed in a plurality of regions. As described above, by allowing at least one of the eight-color display region and the full-color display region to be provided in a plurality of regions, it is possible to make more selections available to the user.

The present invention is not limited to the above-mentioned embodiments, and various modifications can be made without departing from the scope of the claims. That is, embodiments obtained by combining techniques modified without departing from the scope of the claims are also included in the technical scope of the present invention.

### Summary of Embodiments

As described above, in the display device of an embodiment of the present invention, the power source is constituted of a first power source and a second power source that has a higher supply voltage accuracy than that of the first power source, the supply wiring line supplies a voltage from the first power source to each of the data signal lines, and the source amplifier supplies a voltage from the second power source to each of the data signal lines.

With this configuration, voltages can be supplied by using two different power sources.

The display device of an embodiment of the present invention further includes a user input part through which a user inputs information for dividing the display screen into the eight-color display region and the full-color display region.

With this configuration, the user can determine a region to perform the eight-color display and a region to perform the full-color display on the display screen.

In the display device of an embodiment of the present invention, in performing the eight-color display, the power source supplies one of a high gradation voltage and a low gradation voltage to the respective supply wiring lines, and in performing the full-color display, the power source supplies, to the respective source amplifiers, a plurality of gradation voltages corresponding to a plurality of gradation levels obtained by dividing a voltage from the power source by a resistor ladder.

In the display device of an embodiment of the present invention, in performing the eight-color display, the first power source supplies one of a high gradation voltage and a low gradation voltage, and in performing the full-color display, a plurality of gradation voltages corresponding to a plurality of gradation levels are obtained by dividing a voltage from the second power source by a resistor ladder.

With this configuration, in performing the eight-color display, one of the high gradation voltage and the low gradation voltage is supplied without using a source amplifier, making it possible to reduce the power consumed to drive the data signal lines.

In the display device of an embodiment of the present invention, the power source generates a voltage to be supplied from the second power source by conducting voltage conversion on a voltage of the first power source.

With this configuration, it is possible to use a main power source of the display device itself as the first power source.

In the display device of an embodiment of the present invention, at least one of the eight-color display region and the full-color display region is provided in a plurality of regions.

With this configuration, when a plurality of eight-color display regions are provided, for example, it is possible to reduce the power consumption more than when only one eight-color display region can be specified. Also, when a plurality of full-color display regions are provided, it is possible to address the need of the user when the user thinks the full-color display needs to be performed in a plurality of regions.

The specific embodiments and examples provided in the detailed description of the present invention section are merely for illustration of the technical contents of the present invention. The present invention shall not be narrowly interpreted by being limited to such specific examples. Various changes can be made within the spirit of the present invention and the scope as defined by the appended claims.

### INDUSTRIAL APPLICABILITY

Electronic devices that can utilize the display device of the present invention include personal computers, peripheral devices thereof (printers, scanners, and multi-purpose devices, for example), mobile phones, personal digital assistants, audio players, digital cameras, video cameras, television receivers, and projectors, for example.

### DESCRIPTION OF REFERENCE CHARACTERS

1 display device

2 display section

3 setting control part

4 gate voltage output part

5 source output voltage generating part

6 source voltage output part

7 source amplifier

8 setting input part

9 power supply part

10 regulator

11 eight-color display region

12 full-color display region

15, 15′ source amplifier circuit

1. A display device, comprising:
a display screen having a plurality of scan signal lines, a plurality of data signal lines intersecting with the plurality of scan signal lines, and a plurality of pixels provided for respective intersections of the plurality of scan signal lines and the plurality of data signal lines, the display screen being divided into an eight-color display region that performs eight-color display and a full-color display region that performs full-color display;
a power source that supplies a voltage;
a source amplifier circuit provided for each of the data signal lines, the source amplifier circuit comprising a supply wiring line that supplies a voltage from the power source to said data signal line, and a source amplifier that supplies a voltage from the power source to said data signal line;
a calculation part that calculates a gradation voltage for each of the pixels in accordance with a display region in which said pixel is present, based on an image signal inputted from an exterior, the gradation voltage corresponding to a gradation to be displayed in the pixel; and
a control part that causes the gradation voltage calculated by the calculation part to be supplied to each of the data signal lines corresponding to the pixels included in the eight-color display region through the supply wiring line from the power source, the control part also causing the gradation voltage calculated by the calculation part to be supplied to each of the data signal lines corresponding to the pixels included in the full-color display region through the source amplifier from the power source.

2. The display device according to claim 1, wherein the power source is constituted of a first power source and a second power source that has a higher supply voltage accuracy than that of the first power source,
wherein the supply wiring line supplies a voltage from the first power source to one of the data signal lines, and
wherein the source amplifier supplies a voltage from the second power source to one of the data signal lines.

3. The display device according to claim 1, further comprising a user input part through which a user inputs information for dividing the display screen into the eight-color display region and the full-color display region.

4. The display device according to claim 1, wherein, in performing the eight-color display, the power source supplies one of a high gradation voltage and a low gradation voltage to the supply wiring line, and
wherein, in performing the full-color display, the power source supplies, to the source amplifier, one of a plurality of gradation voltages corresponding to a plurality of gradations obtained by dividing a voltage from the power source by a resistor ladder.

5. The display device according to claim 2, wherein, in performing the eight-color display, the power source supplies one of a high gradation voltage and a low gradation voltage, and
wherein, in performing the full-color display, the power source generates a plurality of gradation voltages corresponding to a plurality of gradations by dividing a voltage from the second power source by a resistor ladder.

6. The display device according to claim 2, wherein the power source generates a voltage to be supplied from the second power source by conducting voltage conversion on a voltage from the first power source.

7. The display device according to claim 1, wherein at least one of the eight-color display region and the full-color display region is provided in a plurality of regions.

8. A display method for a display device including a display screen having a plurality of scan signal lines, a plurality of data signal lines intersecting with the plurality of scan signal lines, and a plurality of pixels provided for respective intersections of the plurality of scan signal lines and the plurality of data signal lines, and a power source that supplies a voltage, the display screen being divided into an eight-color display region that performs eight-color display and a full-color display region that performs full-color display, the display method comprising:
a calculation step of calculating a gradation voltage for each of the pixels in accordance with a display region in which said pixel is present, based on an image signal inputted from an exterior, the gradation voltage corresponding to a gradation to be displayed in the pixel; and
a control step of causing the gradation voltage calculated in the calculation step to be supplied to each of the data signal lines corresponding to the pixels included in the eight-color display region through a supply wiring line from the power source, and causing the gradation voltage calculated in the calculation step to be supplied to each of the data signal lines corresponding to the pixels included in the full-color display region through a source amplifier from the power source.
